(19) United States
(12) Patent Application Publication
(10) Pub. No.: US 2016/0316938 A1
(43) Pub. Date: Nov. 3, 2016

(54) MERCHANDISE DISPLAY INVENTORY SYSTEM

(71) Applicant: STC LABORATORIES LLC, Grand Rapids, MI (US)

(72) Inventors: Thomas William Cruttenden, Rockford, MI (US); Patrick Kapenga, Grand Rapids, MI (US)

(21) Appl. No.: 15/108,550

(22) PCT Filed: Dec. 23, 2014
(86) PCT No.: PCT/US14/72154

§ 371 Date: Jun. 27, 2016

Related U.S. Application Data
(60) Provisional application No. 61/921,149, filed on Dec. 27, 2013.

(51) Int. Cl. A47F 10/00; A47F 3/00; G06Q 10/08; A47F 1/12

(52) U.S. Cl. CPC A47F 10/00; A47F 1/125; A47F 3/002; G06Q 10/087; A47F 2010/005

(57) ABSTRACT

A merchandise display inventory system includes a pusher assembly containing a pusher that biases product on a rack toward the front of the rack and an electrical circuit that produces a voltage relating to the position of the pusher. Software calculates the inventory of cigarette packs on the racks from the voltage.

### CROSS REFERENCE TO RELATED APPLICATIONS

The present application claims the benefit of U.S. Provisional Patent Application No. 61/921,149, entitled CIGARETTE PACK HOLDING RACK INVENTORY SYSTEM, filed on Dec. 27, 2013, the entire contents of which are incorporated by reference.

### TECHNICAL FIELD

The invention relates generally to inventory management of retail merchandise.

### BACKGROUND

A major cost in the operation of retail stores relates to inventory management, which includes the tracking and storing of inventory. A portion of this cost, when the retail store sells cigarettes, relates to cigarette pack inventory management. A considerable portion of this inventory management cost is the periodic counting of merchandise, for example cigarette packs. on the store cigarette pack holding racks. This counting is necessary to determine the amount of product on the racks and to help ensure the racks are filly stocked.

Commonly, the counting of merchandise inventory on store racks is done manually at periodic times throughout the day and the results are recorded manually on a log. When a cigarette pack is sold. it is scanned using a point of sale (POS) system. The manual recorded inventory may then be compared with the record of sale from the POS. This process results in significant labor and introduces human error

Another significant cost relating to inventory management is product theft. Cigarettes and other merchandise represent a high value to potential thieves who can either resell the items or consume them. The tosses generated by such thefts have a negative impact on the profitability of the retail stores.

Theft can be the result of both customers and employees actions and has been difficult to eliminate. Attempts to deter and prevent theft have proven to be only partially effective. For instance, in-store cameras often do not observe the theft clearly enough to catch or prosecute the thief. In addition, in-store security personnel are rarely in the correct position to actually observe a thief in action. As a result, theft continues to be a significant problem and cost in the management of inventory. It would be beneficial to provide aid in monitoring for theft.

Currently, retail stores can track the amount of any given item of merchandise sold based on the number of items scanned at the checkout counter. While this ability has proven useful, certain inherent disadvantages result from the use of such a system. One inherent disadvantage is that the scanner only counts the number of items that are legitimately purchased. Therefore, if items are removed from the shelf but not purchased, the store is unable to determine the fact that those items have been misplaced or stolen without visual inspection or detection. It would be useful to compare changes in the level of particular merchandise on the racks with the amount of such merchandise sold.

With reference to FIG. 1, there is shown a perspective view of a typical store 8 with cigarette pack holding racks 10 behind the counter 12. Cigarette packs 14 are manually counted at periodic times throughout the day and the counts are recorded manually in a log 16. When a cigarette pack 14 is sold, it is scanned using a point of sale (POS) system 18. The inventory manually recorded in the log 16 may then be compared with the records of the sales receipts from the POS 18.

### BRIEF SUMMARY

The merchandise display inventory system of the present invention includes a merchandise display with an inventory monitor, for monitoring the amount of inventory in the display, including additions and subtractions to the inventory. The inventory display monitor is operably connected to a computer programmed to track the inventory in the display. This facilitates the following processes:

1. The computer can be programmed to generate inventory management reports. These can be used to identify brands which are not moving satisfactorily. The reports can be compared to a point of sale reports to identify inventory shrinkage, which may be an indication of theft;

2. The point of sale information can be sent to the computer, which can be programmed to continuously compare point of sale information to display inventory information, and generate real time comparative reports to identify potential theft or other sources of shrinkage. Real time alerts can be automatically generated and sent to designated persons.

3. The computer can provide a continual readout at the point of sale, such that a clerk can know when merchandise is removed from the display, and generate an immediate alert if the merchandise is not brought to the point of sale for purchase.

These and other objects, advantages and features of the invention will he more filly understood and appreciated by reference to the Description of the Preferred Embodiments, including appended drawings.

### BRIEF DESCRIPTION OF THE DRAWINGS

FIG. 1 is a perspective view of a store with a cigarette pack holding rack behind a convenience store counter of the prior art

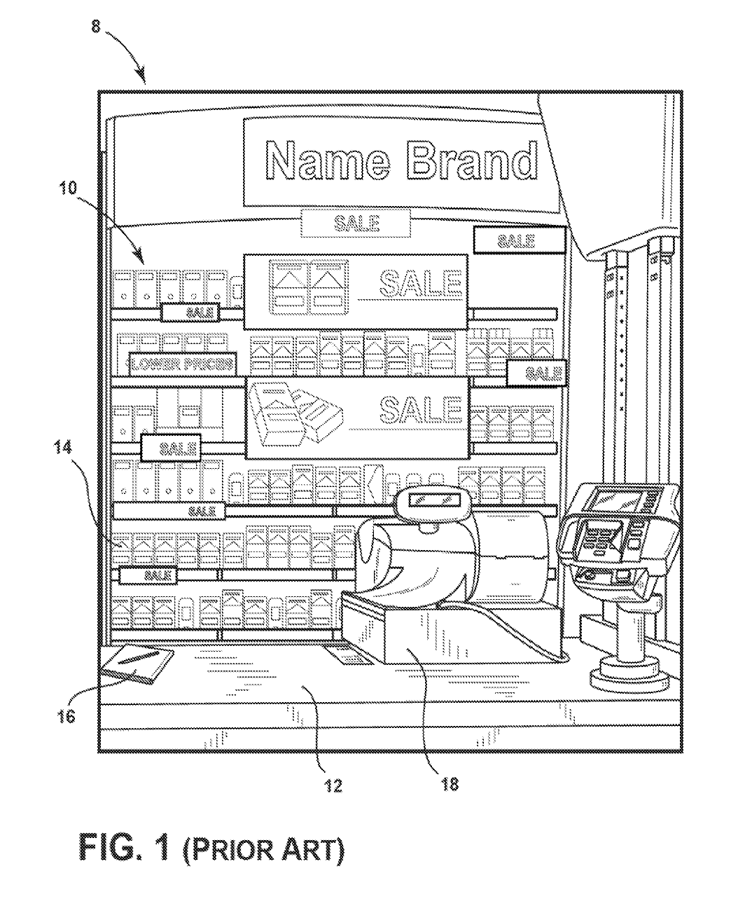

FIG. 2 is a perspective view a cigarette pack holding rack of the prior art.

FIG. 3 is an elevational view of a cigarette pack holding rack inventory system according to an embodiment of the invention.

FIG. 4 is a perspective view of the cigarette holding rack provided with an electrical circuit according to an embodiment of the invention.

FIG. 5 is a schematic view of a cigarette pack holding, rack inventory system according to an embodiment of the invention.

FIG. 6 is an illustration an inventory display screen showing the current inventory counts window according to an embodiment of the invention.

FIG. 7 is an illustration an inventory display screen showing the moved inventory counts window according to an embodiment of the invention.

FIG. 8 is an illustration of an inventory display screen showing the measurement details window of the current inventory counts according to an embodiment of the invention.

FIG. 9 is an illustration an inventory display screen showing movement details of the moved inventory counts window according to an embodiment of the invention.

FIG. 10 is an illustration of an inventory display screen showing an alert window according to an embodiment of the invention.

### DETAILED DESCRIPTION

In accordance with one embodiment of the invention, a cigarette pack holding rack includes a pusher assembly containing a pusher that biases product on a rack toward the front of the rack. An electrical circuit is provided, where the electrical circuit produces a voltage relating to the position of the pusher. A microcontroller monitors the electrical circuit and transmits data representative of the position of the pusher. In an embodiment, the data is transmitted to a store computer having software.

Software on the store computer allows the determination of inventory levels. The determination of inventory can be done in real time.

In another embodiment of the invention, the software may be integrated with the store point of sale (POS) system. The inventory levels can be compared to the records of sale on the POS in real time.

In yet another embodiment, the software on the store computer may provide an alert when a when a possible theft of a cigarette pack occurs. The alert may display surveillance footage of the cigarette pack holding rack at the time of the possible theft.

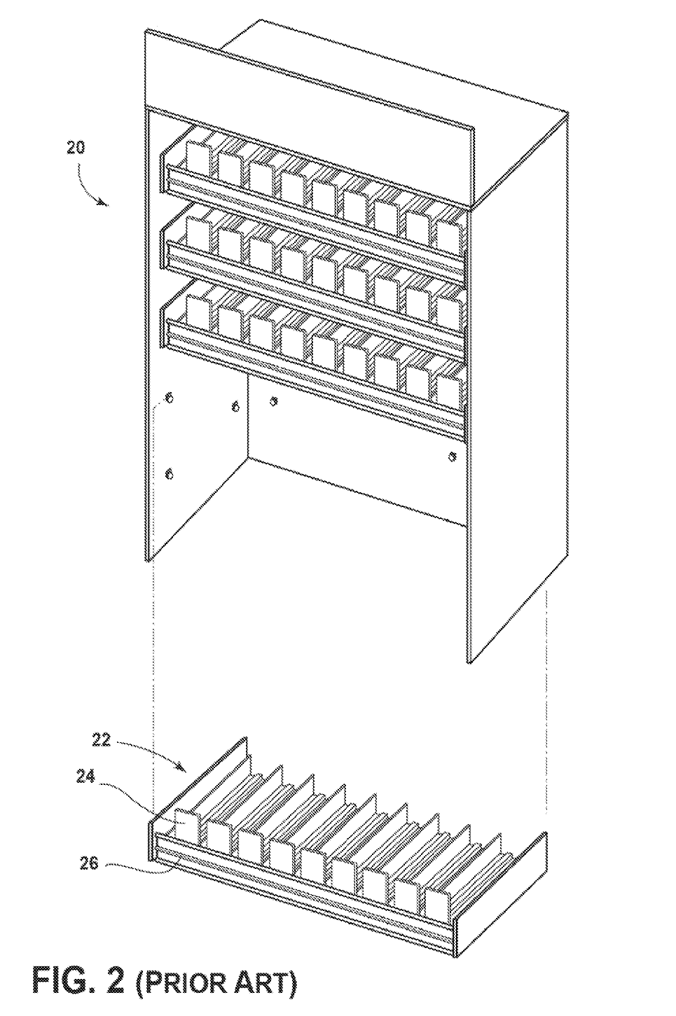

Turning now to the drawings and to FIG. 2 in particular, FIG. 2 shows a perspective view of a common display case 20 having cigarette pack holding racks 22 (referred to herein as a rack) that include a pusher assembly 24 that biases product on a racks 22 toward the front 26 of the racks

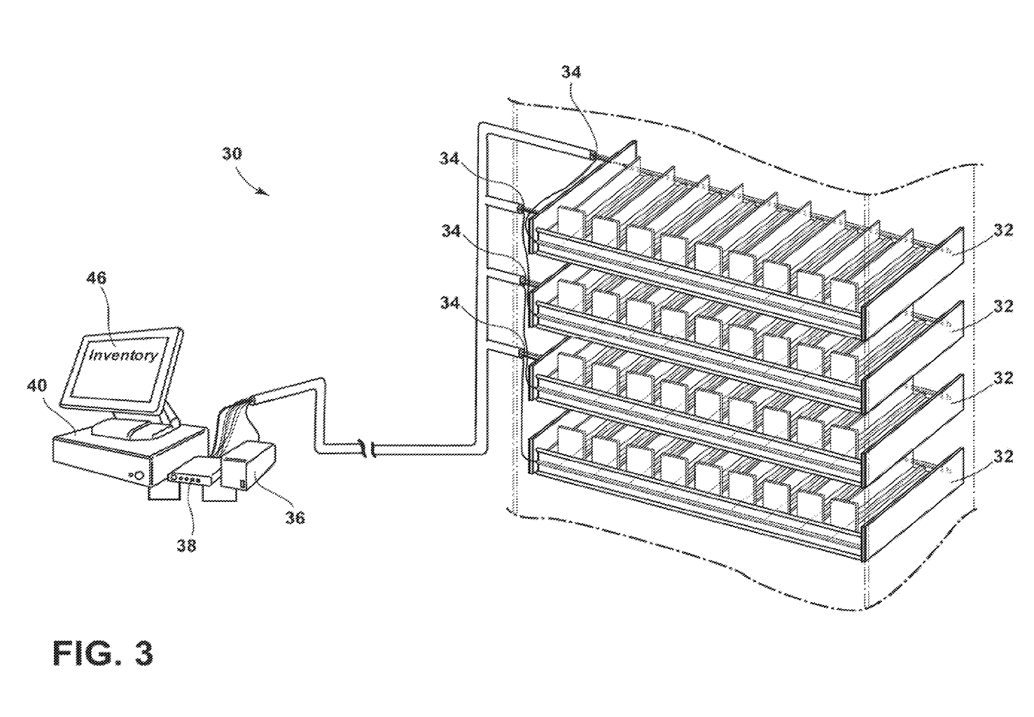

FIG. 3 shows an elevational view of a cigarette pack holding rack inventory system 30 according to a preferred embodiment of the invention. A plurality of racks 32 are provided with electrical circuits 34. A power supply 36 is in electrical connection with the electrical circuits 34. A microcontroller 38 is in electrical connection with the power supply 36 and electrical circuits 34. A computing device 40 is in electrical connection with the microcontroller 38.

The power supply 36 supplies power to the electrical circuits 34 on the racks 32. The electrical circuits 34 provide an electrical signal indicative of the number of cigarette packs in each row of the racks 32. The microcontroller 38 controls the power supplied to each electrical circuit 34, monitors the electrical circuits 34 measures electrical data of the electrical circuit 34 and transmits data representative of the number of cigarette packs in each row of the racks 32. The data is transmitted to computing device 40 such as a store computer. The computing device 40 contains software to control the microcontroller 38 and to interact With data sent from the microcontroller 38 and an inventory display 46 screen for displaying information from the software. When the software receives data from the microcontroller 38; it calculates, tracks and displays information relating to the inventory of each row of cigarette packs in the racks 32.

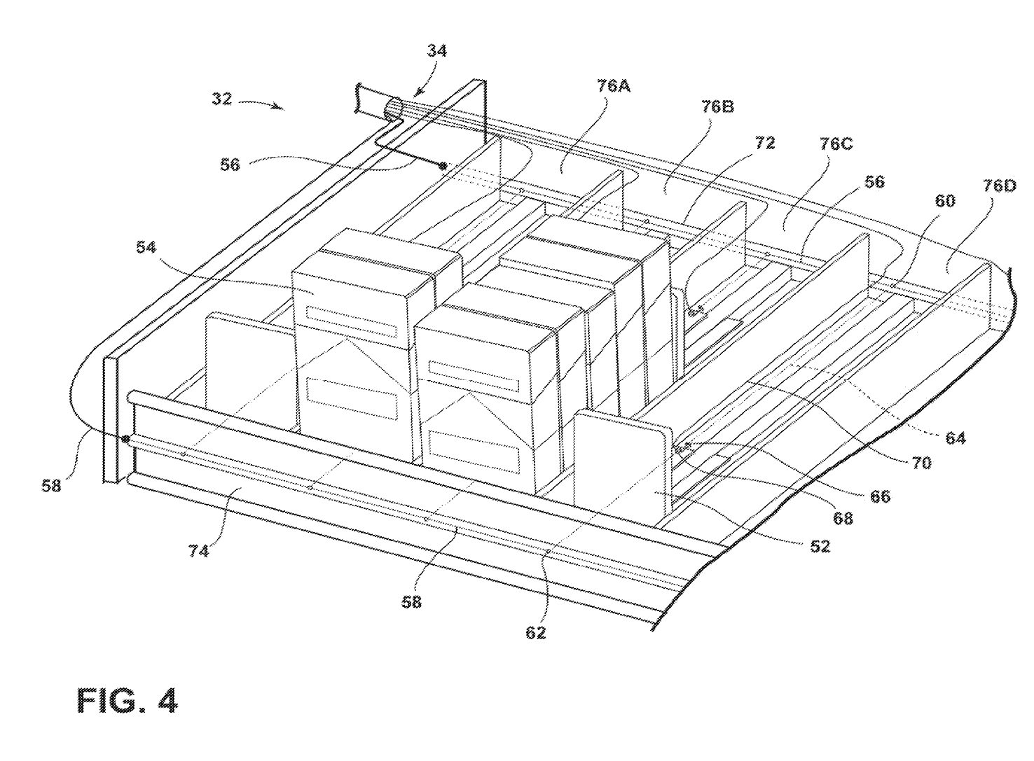

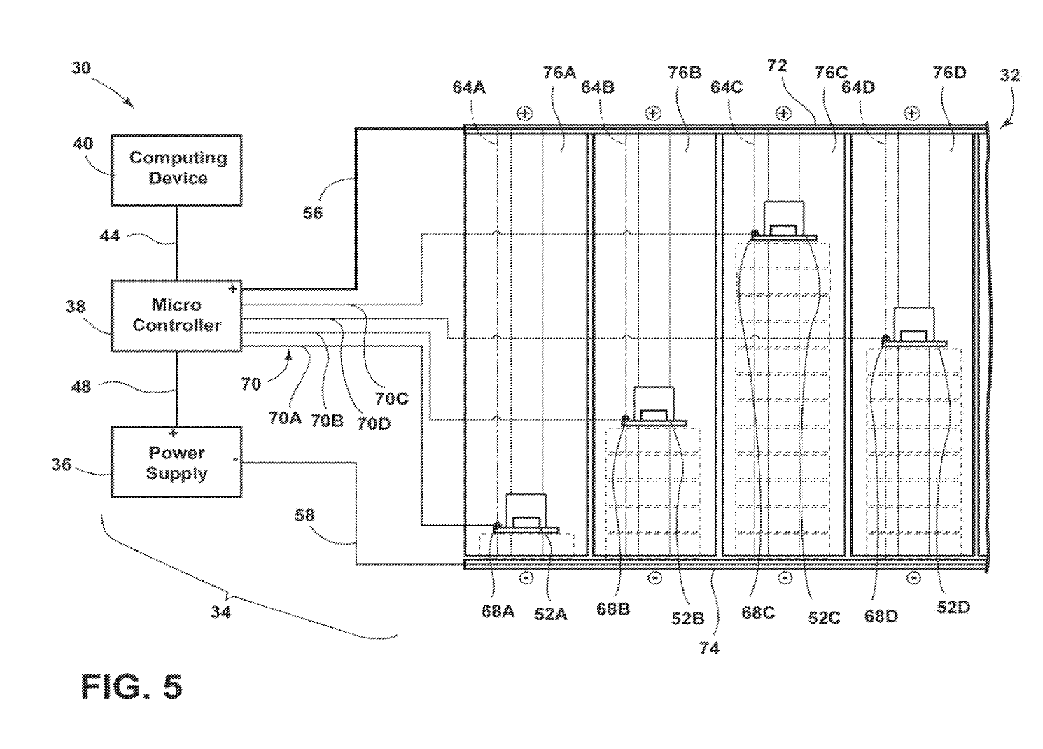

FIG. 4 is a perspective view of the rack 32 provided with an electrical circuit 34 according to a preferred embodiment of the invention. The rack 32 has a plurality of rows 76A -76D for holding cigarette packs 54. A pusher assembly 52A-52D is disposed in each row 76A-76D of the rack 32 and is configured to bias the cigarette packs 54 to the front side 74 of the row 76 using a biasing device such as a spring (FIGS. 4 and 5). Each electrical circuit provided on each rack 32 comprises a first bus wire 56 that is disposed at the back side 72 of the rack 32 and a second bus wire 58 that is disposed at the front side 74 of the rack 32 where both the first wire 56 and second wire 58 run perpendicular to the rows 76. The first bus wire 56 serves as a current input bus, and the second wire 58 serves as a ground bus. Each row 76A-D has third wire 64A-64D with a resistance that changes based on the length of the wire 64 that runs along each row 76 perpendicular to the first wire 56 and second wire 58. One side of the third wire 64 is connected to a terminal 60 disposed on the first wire 56 and the opposite side of the third wire 64 is connected to a terminal 62 disposed on the second wire 58. A fourth wire 66 connects the pusher assembly 52 to the third wire 64 (FIG. 4). The fourth wire 66 is slidably connected to the third wire 64 so that the location of the connection the third wire 64 moves in relation to the pusher assembly 52. The fourth wire 66 connects to a terminal 68 on the pusher assembly 52. A fifth wire 70 connects to the pusher assembly 52 at terminal 68 or at a location that is electrical connection with the fourth wire 66. There is a third wire 64A-64D and a fifth wire 70A-70D for each row 76A-76D.

In another embodiment, the fourth wire 66 could be any electrical connection that allows the pusher assembly 52 to be in electrical connection with the third wire 64 and allows the location of the connection to the third wire 64 to move in relation to the pusher assembly 52. In one example, a slidable terminal may be integrally formed in the pusher assembly so that it slides along the third wire 64 as the pusher assembly 52 moves while maintaining an electrical connection between the third wire 64 and the pusher assembly 52.

Now referring to FIG. 5, there is shown a schematic view of a cigarette pack holding rack inventory system 30 and rack 32 according to a preferred embodiment of the invention. The power supply 36 is connected to the first wire 56 running to the rack 32 by a wire 48 and the microcontroller 38. The second wire 58 rims from the rack 32 to the power supply 36. The fifth wires 70A-D connected to the pusher assemblies 52A-D at terminals 68A-D run from the rack 32 to the microcontroller 38. The microcontroller 38 is connected to the computing device 40 by a wire 44.

According to one embodiment of the invention, the software on the computing device 40 sends a signal to the microcontroller 38 instructing the microcontroller 38 to take an inventory measurement of the rows 76 in the racks 32. The microcontroller 38 responds by pulsing a current from the power supply 36 through an electrical circuit 34 in each rack 32, comprising the first wire 56, third wires 64A-D and the fifth wires 70A-D corresponding to their respective rows 76A-D in one of the racks 32. A pusher assembly 52 and the terminal 68 are positioned along the row 76 and the third wire 64 dictated by the number of cigarette packs in the row 76. Because the resistance of the third wire 64 is dependent on the length of the third wire 64, the length of the third wire 64 segment between the first wire 56 and terminal 68 has a resistance that changes based on the number of cigarettes packs in that row 76. When the microcontroller pulses a current through a the circuit 34 in a rack 32, the microcontroller 38 takes a voltage reading between each fifth wire 70A-D and the ground wherein the voltage reading is dependent on the resistance of the third wire 64 segment between the first wire 56 and the terminal 68. The voltage data is transmitted to the computing device 40 where the software calculates the number of cigarette packs in each row 76A-D based on the voltage data of each row 76A-D. As more cigarette packs are added to the row 76, the length of the third wire 64 segment between the first wire 56 and the terminal 68 becomes shorter and therefore the resistance of the third wire 64 segment becomes less and the voltage measurement of the fifth wire 70 connected to the terminal 68 becomes less. As more cigarette packs are removed from the row 76, the length of the third wire 64 segment between the first wire 56 and the terminal 68 becomes longer and therefore the resistance of the third wire 64 segment becomes greater and the voltage measurement of the fifth wire 70 connected to the terminal 68 becomes greater.

In another embodiment, the current is pulsed through the circuits 34 for time periods in the range of 100 milliseconds. This prevents the wires the circuit from generating heat above a predetermined threshold. In another embodiment, the microcontroller may pulse a current through each of the circuits 34 multiple times so that the software may average the different measurements before calculating the number of cigarette packs in each row 76 in the rack 32. It will be understood that the time range described herein is by example only, and the particular time range used in the example embodiment provided herein should not be construed as limiting on the invention. Where there are multiple racks 32 and hence multiple circuits 34 as shown in FIG. 3, each circuit can be pulsed individually and in series. Thus one circuit 34 can be pulsed, the product in each associated row determined, and then the next circuit 34 can be pulsed, and so on.

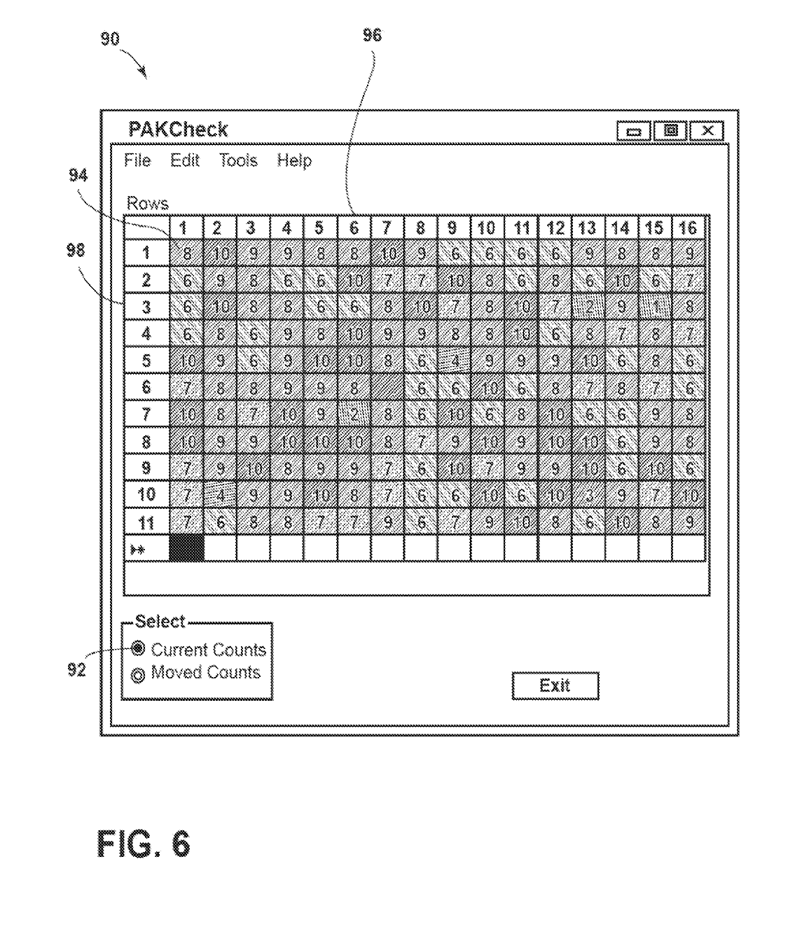

FIG. 6 shows an illustration an inventory display screen 46 showing a current inventory counts window according to an embodiment of the invention. An operator may view the current inventory counts window 90 by selecting a current counts function 92. Each cell 94 on the display screen shows a number corresponding to a number of cigarette packs disposed in one row 76 of one rack 32. The columns 96 represent the different rows 76 in each rack 32 and the rows 98 represent the different racks 32. The cells 94 may be color coded so that different colors are displayed in cells 94 depending on the number displayed in that cell 94. For example, a cell 98 may show the color red if a small amount of cigarette packs are in that corresponding row 76 and 32. A cell 98 may show the color green if a relatively large amount of cigarette packs are in that corresponding row 76 and rack 32. It will be understood that the layout and features of the current inventory counts window described herein is by example only, and the particular layout and features used in the example embodiment provided herein should not be construed as limiting on the invention.

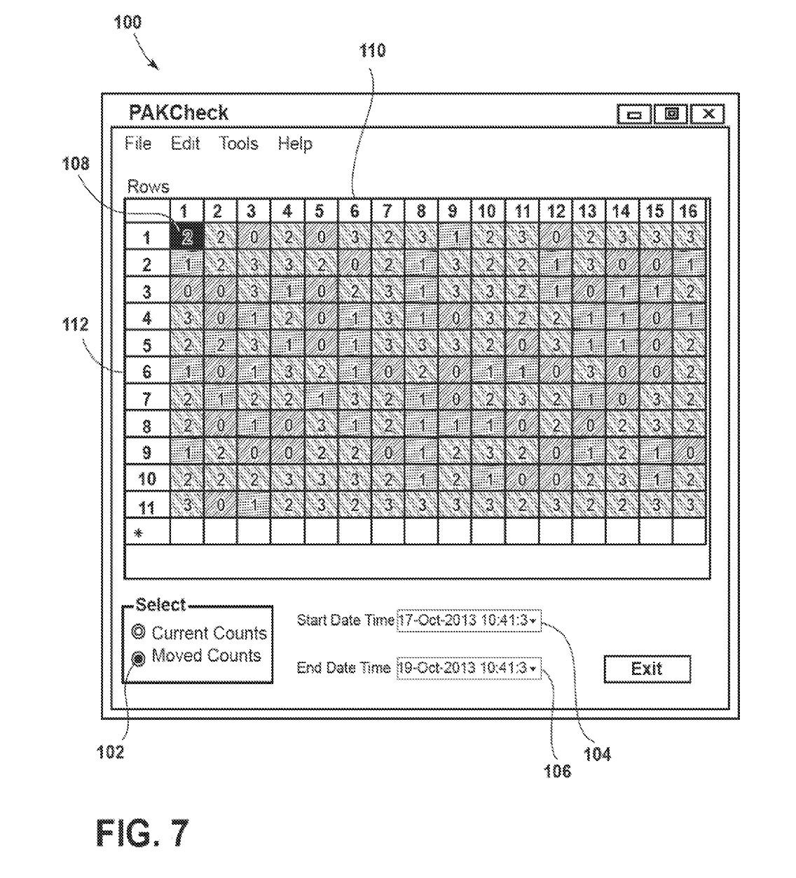

FIG. 7 shows an illustration an inventory display screen 46 showing the moved inventory counts window 100 according to an embodiment of the invention. An operator view the moved inventory counts window 100 by selecting a moved counts function 102. The moved inventory count window 100 may display the change in inventory counts over a specified amount of time defined by an operator. The operator may select the start date and time 104 and the end date and time 106 for which the moved inventory counts window 100 displays the moved inventory counts. Each cell 108 on the moved inventory counts window 100 shows a number corresponding to a number of cigarette packs moved to or from one row 76 of one rack 32 over a set period of time.

The operator may choose to display only cigarette packs added to the racks over a set period of time, the cigarette packs removed from the racks 32 over a set period of time or the difference between cigarette packs added and cigarette packs removed to and from the racks 32 over a set period of time. The columns 110 represent the different rows 76 in each rack 32 and the rows 112 represent the different racks 32. The cells 108 may be color coded so that different colors are displayed in cells 108 depending on the number displayed in that cell 108. For example, a cell 108 may show the color red if a small amount of cigarette packs have been moved from that corresponding row 76 and 32. A cell 108 may show the color green if a relatively large amount of cigarette packs have been removed from that corresponding row 76 and rack 32. It will be understood that the layout and features of the moved inventory counts window described herein is by example only, and the particular layout and features used in the example embodiment provided herein should not be construed as limiting on the invention.

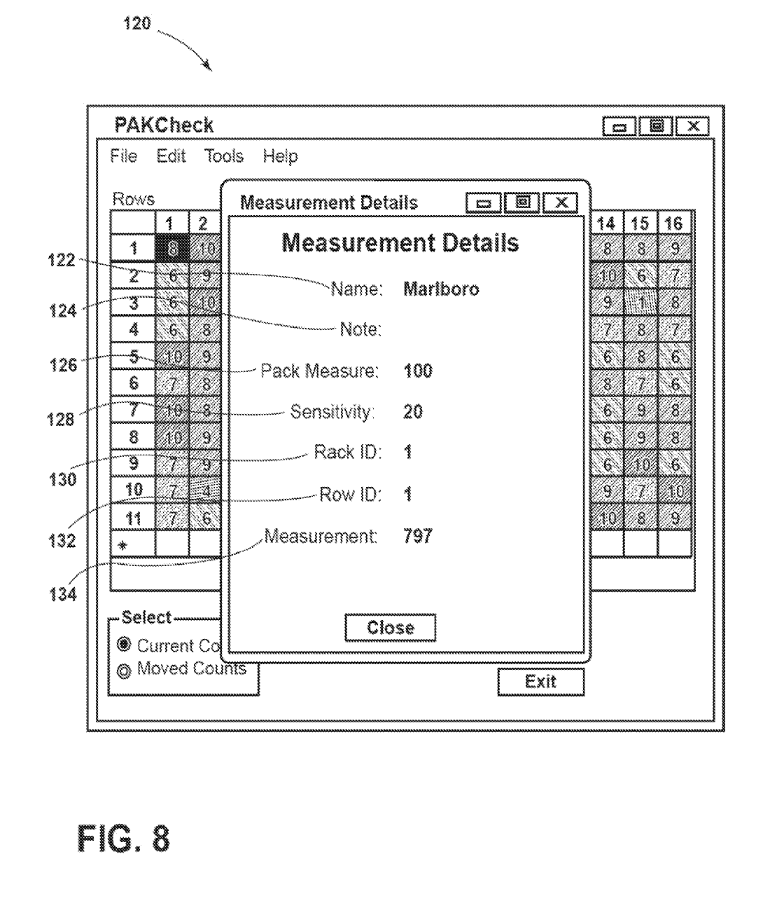

FIG. 8 shows an illustration of an inventory display screen 46 showing a measurement details window 120 of the current inventory counts according to an embodiment of the invention. By selecting a cell 94 on the current inventory count window 90, a measurement details window 120 may be displayed. The measurement details window 120 may show a plurality of information corresponding to the selected cell 94 including, but not limited to the name of the product name general notes 124, the pack measurement 126, the pack sensitivity 128, the rack identification number 130 (ID) the row ID 132 and the current measurement 134. The pack measure 126 is the amount of units calculated from the voltage data representative of one cigarette pack. For example, a voltage reading from the microcontroller in a row 76 of a rack 32 containing one cigarette pack may he represented by 100 units in the software. Therefore, the pack measure is 100. The measurement 134 is the amount of units calculated from the voltage measurement in a row 76 of a rack 32 corresponding to the number of cigarette packs in the row 76 of a rack 32 displayed in the cell 94. For example, a measurement 134 of 800 units with a pack measure of 100 units corresponds to 8 packs of cigarettes because a measurement 134 of 800 divided by a pack measure 126 of 100 is 8. The sensitivity 128 is the amount of allowable error in the measurement 134 with respect to an ideal measurement based on multiples of the pack measurement 126. For example a row 76 in a rack 32 containing 8 packs of cigarettes with a measurement 134 of 797 units, a pack measurement 126 of 100 units and a sensitivity 128 of 20 units would have an ideal pack measurement of 800 units and would display 8 in the cell 94 because the measurement 134 is between 780 and 820. A measurement 134 with the last two digits between 20 and 80, a pack measurement 126 of 100 units and a sensitivity 128 of 20 units may be programmed to display an error screen because the measurement 134 falls outside of 20 units from an ideal measurement.

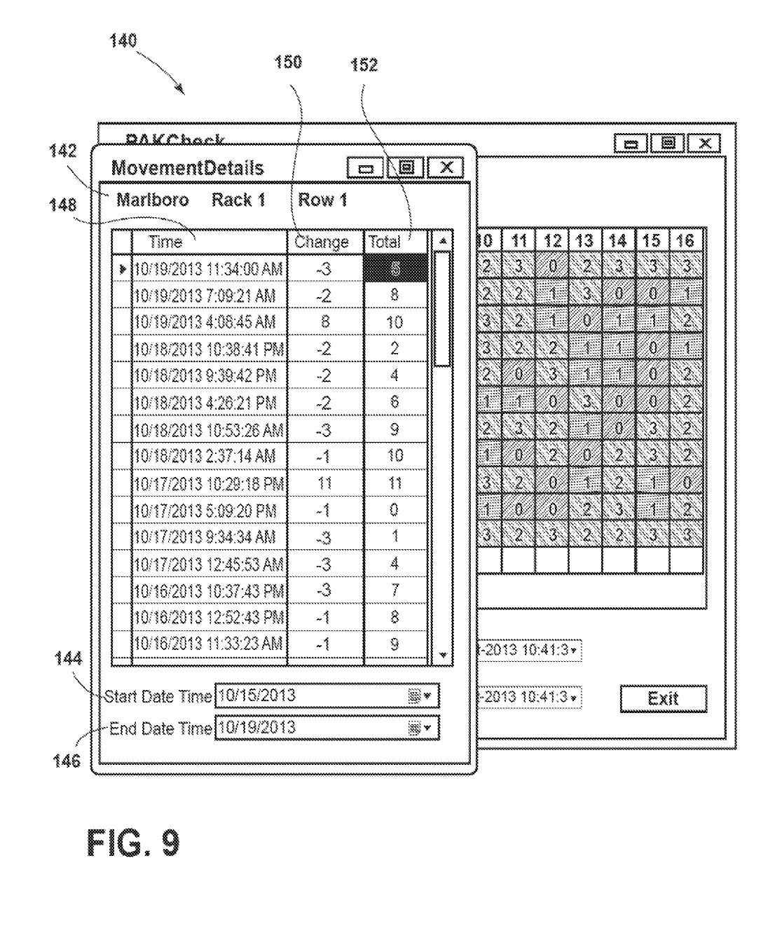

FIG. 9 shows an illustration of an inventory display screen 46 showing a movement details window 140 of the moved inventory counts according to an embodiment of the invention. By selecting a cell 108 on the moved inventory counts window 100, a movement details window 140 may be displayed. The operator may select a start date and time 114 and an end date and time 146 for the movement details window 120 so that movement data between the selected dates and time will be displayed. The movement details window 120 may show a plurality of information corresponding to the selected cell 108 including but not limited to the selected rack ID, row ID and product name 170, the change 150 in cigarette packs, the date and time 148 of the change 150 and the total 152 number of cigarette pack in a row 76 of a rack 32 after the change 150. The change 150 may be positive or negative depending on if cigarette packs were added or removed from the row.

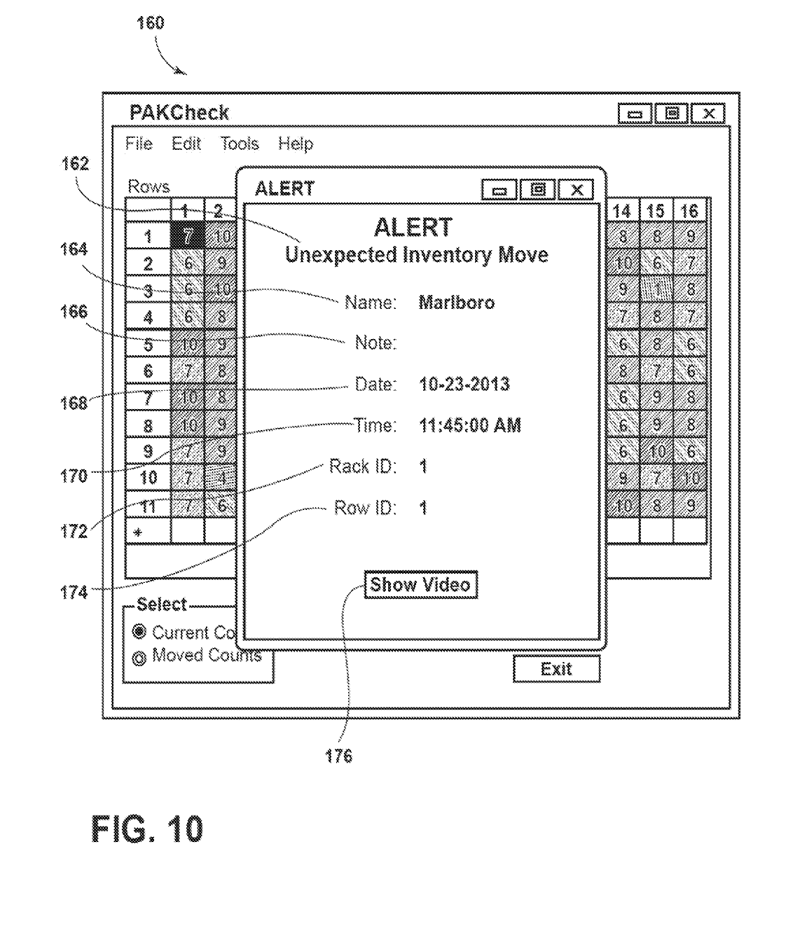

FIG. 10 shows an illustration of an inventory display screen 46 showing an alert window 160 according to an embodiment of the invention. The software may be configured to monitor the POS sales receipts of the different cigarette packs. When comparing the movement details of each row 76 of each rack 32 of cigarette packs with the PUS sales receipts, the number of cigarette packs removed from a row 7 of a rack 32 may be compared with the number of cigarette packs sold from that row 76 of that rack 32. Therefore, if there is a difference between the POS sales receipts and the inventory movement, an alert is generated. There may be a time delay on the alert to account for the time of removal of a cigarette pack to the time of sale on the POS. The alert window 160 may show a plurality of information including but not limited to an alert description 162, the name 164 of the product corresponding to the alert, a note 166, the date 168 the alert occurred, the time 170 the alert occurred, and the rack ID 172 and the row ID 174 corresponding to the alert. Furthermore, the software may be connected to the in store surveillance cameras so that when an alert window 160 is generated, it may contain a show video function 176 that displays the surveillance footage of the racks 32 at the time the possible theft was detected.

In another embodiment of the invention, radio frequency identification (RFID) system consisting of RFID tags and a reader may be used in conjunction with software to manage the cigarette pack inventory. RFID tags could be placed on the pusher assemblies so that as the pusher assemblies changed position, the signal feedback strength sent to the reader changes. The software could then calculate the number of packs of cigarettes in each row of each rack using the signal feedback strengths.

In another embodiment of the invention, a Bluetooth system consisting of a plurality of Bluetooth master devices and slave Bluetooth devices may be used in conjunction with software to manage the cigarette pack inventory. Slave Bluetooth devices could be placed on the pusher assemblies so that as the pusher assemblies changed position, the signal. feedback strength sent to the master Bluetooth devices changes. The software could then calculate the number of packs of Cigarettes in each row of each rack using the signal feedback strengths.

In another embodiment of the invention, analog or digital sensors could be used to provide the software with a data corresponding to the position of the pusher assemblies. The software could then calculate the number of packs of cigarettes in each row of each rack using the data from the sensors.

The cigarette pack holding rack inventory system as described in the invention has the ability to both reduce labor costs and deter theft. By providing a real time automated inventory system and integrating is with POS and security systems, manually inventory labor costs can be eliminated and theft can be deterred. The system and methods described herein may also be applied to any product which uses a racking system comprising a biasing pusher assembly, which could help further reduce labor costs and theft of multiple product.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention including making and using any devices or systems and performing an incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A merchandise display inventory system comprising: a merchandise display; an inventory monitor associated with said merchandise display, for monitoring the amount of inventory in said display, including additions and subtractions to the inventory; said inventory display monitor being operably connected to a computer programmed to track the inventory in said display.

2. The merchandise display inventory system of claim 1 comprising: said computer being programmed to generate inventory management reports which identify brands of products which are not moving satisfactorily.

3. The merchandise display inventory system of claim 1 in which said computer is also programmed to receive point of sale information and to continuously compare point of sale information to display inventory information, and generate real time comparative reports to identify potential theft or other sources of shrinkage.

4. The merchandise display inventory system of claim 3 in which real time alerts are automatically generated by said computer and sent to designated persons.

5. The merchandise display inventory system of claim 1 in which said computer provides a continual readout at the point of sale, such that a clerk can know when merchandise is removed from said merchandise display, and generate an immediate alert if the merchandise is not brought to the point of sale for purchase.

6. The merchandise display inventory system of claim 29 in which: said location sensor comprising an electrical circuit associated with said row and said pusher, which produces a voltage relating to the position of said pusher in said row;
a microcontroller monitors said electrical circuit and transmits data representative of the position of the pusher to said computer which is programmed to determine inventory levels based on that information.

7. The merchandise display inventory system of claim 9 which includes a display screen for displaying information from said computer, said computer being operable to display the product content of each of said rows.

8. (canceled)

9. The merchandise display inventory system of claim 29 in which said holding rack comprises: a plurality of said rows in which product is located.

10. The merchandise display inventory system of claim 6 in which inventory measurements are made by pulsing current through said electronic circuit, in order to prevent said resistance wire from overheating.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. The merchandise display inventory system of claim 1 in which: said merchandise display comprises a product holding rack which includes at least one row in which product can be located; a pusher that biases product on toward the front of said product holding rack row; a location sensor being operably connected with each said pusher; said location sensor being operably connected to said computer; said computer being programmed to calculate the number of items in each row of each rack using location information received from said location sensor.

30. The merchandise display inventory system of claim 29 in which: said location sensor comprises an RFID tag on each said pusher; said RFID tag on said pusher being operably connected to said computer via an RFID reader for each said pusher, located in a permanent location on said merchandise display, such that as the pusher assemblies changed position, the signal feedback strength sent to the reader changes; said RFID reader being operably connected to said computer; said computer being programmed to calculate the number of items in each row of each rack using said signal feedback strengths.

31. The merchandise display inventory system of claim 29 in which: said location sensor comprises a wireless slave device on each said pusher, which sends a signal in response to a signal received from a wireless master device; a wireless master device for each said pusher, located in a permanent location on said merchandise display, such that as the pusher assemblies changed position, the signal feedback strength sent from said wireless slave device to said wireless master changes; said wireless slave device on said pusher being operably connected to said computer via said wireless master device being operably connected to said computer; said computer being programmed to calculate the number of items in each row of each rack using said signal feedback strengths.

32. The merchandise display inventory system of claim 1 in which said merchandise display comprises a plurality of product holding racks, each of which includes a plurality of rows in which product can be located; said system including a display screen for displaying information received from said computer; said computer being programed to display an array of a plurality of cells in a plurality of cell rows and cell columns; each cell showing information concerning product disposed in one of said rows of one of said racks; either the cell columns or the cell rows representing the different rows of product in a given rack, and the other of the cell columns or the cell rows representing the different racks.

33. The merchandise display system of claim 32 in which: said system including a current inventory function which causes said display cells to display current product inventory content of its respective holding rack row.

34. The merchandise display system of claim 33 in which: said system including a moved inventory function which causes said display cells to display inventory moved from its respective holding rack row for a specified period of time.

35. The merchandise display system of claim 34 in which: said system including a function indicating the difference between product added to and product removed from the racks over a set period of time, which causes said display cells to display a number corresponding to the difference between product added to and product removed from its respective holding rack row.

36. The merchandise display inventory system of claim 32 in which said system includes a product information function which causes said display screen to display a window containing product information relative to product located in a particular one of said rows of said racks; said function being activated by selecting a particular cell from said array of cells.

37. The merchandise display inventory system of claim 32 in which said system includes a product movement information function which causes said display screen to display a window containing product movement information relative to product located in a particular one of said rows of said racks; said function being activated by selecting a particular cell from said array of cells.

38. The merchandise display inventory system of claim 1 in which said computer is also programmed to receive point of sale information and to continuously compare point of sale information to display inventory information; said system including an alert function which causes said display screen to display a window showing a difference between the POS sales receipts and the inventory movement data relative to product located in a particular one of said rows of said racks, said display being activated automatically in response to such a difference.

39. The merchandise display inventory system of claim 38 in which said computer is connected to in store surveillance cameras so that when said alert window is generated, it activates a show video function that displays the surveillance of said racks at the time possible theft was detected.
